(19) United States
(12) Patent Application Publication
(10) Pub. No.: US 2015/0273340 A1
(43) Pub. Date: Oct. 1, 2015

(54) ADAPTIVE GAME ENHANCEMENT FOR MULTIPLAYER ONLINE GAMES

(71) Applicant: LENOVO ENTERPRISE SOLUTIONS (SINGAPORE) PTE. LTD, SINGAPORE (SG)

(72) Inventors: Gary D. Cudak, Wake Forest, NC (US); Lydia M. Do, Raleigh, NC (US); Christopher J. Hardee, Raleigh, NC (US); William G. Pagan, Durham, NC (US); Adam Roberts, Moncure, NC (US)

(73) Assignee: International Business Machines Corporation, Armonk, NY (US)

(21) Appl. No.: 14/224,811

(22) Filed: Mar. 25, 2014

(51) Int. Cl. A63F 13/798; A63F 13/35

(52) U.S. Cl. CPC A63F 13/798; A63F 13/35

(57) ABSTRACT

In an approach to determine achievements for online computing game users, a computer identifies one or more game actions of a first user and one or more game actions of a plurality of users for one or more online computing games. The computer determines a game action of the first user is substantially similar to a game action of at least one user of the plurality of users, and in response, the computer identifies a group of users that includes at least the first user and the at least one user of the plurality of users. The computer then determines at least one achievement for the group of users, based, at least in part, on the game action of the first user and the game action of the at least one user.

### FIELD OF THE INVENTION

The present invention relates generally to video game technology, and more particularly to determining adaptive game enhancement in a multiplayer online gaming environment.

### BACKGROUND OF THE INVENTION

With the pervasive growth of computing products that have become easier to access and are able to provide high quality graphics, such as gaming systems, portable computing devices, smart phones and desktop computers, the opportunities for growth in the gaming world are quickly evolving. Many computer games provide online, multiplayer game worlds with lifelike graphics, allowing users to select and customize complex characters or avatars that interact with other players, animated creatures, non-player characters (NPC), objects, and various locations. Users perform various actions in an attempt to complete a series of tasks, or to attain objectives, objects, or skills in order to progress to interim goals within a game or to an ultimate game goal. Games that create elaborate virtual worlds and allow multiple players to inhabit and interact in these virtual worlds can be massively multiple player online games. Massively multiple player online games are often provided over the internet and run by game service providers who derive revenue from player subscriptions to the gaming service and the massively multiplayer games offered. A game's popularity and the length of the game's popularity vary by game for the variety of games provided by the game service providers.

### SUMMARY

Embodiments of the present invention disclose a method, computer program product, and computer system for determining achievements for online computing game users. The method includes a computer identifying one or more game actions of a first user for one or more online computing games and the computer identifying one or more game actions of a plurality of users for the one or more online computing games. The computer determines that a game action of the first user is substantially similar to a game action of at least one user of the plurality of users, and in response, the computer identifies a group of users where the group of users includes at least the first user and the at least one user of the plurality of users. The computer then determines at least one achievement for the group of users, based, at least in part, on the game action of the first user and the game action of the at least one user.

### BRIEF DESCRIPTION OF THE SEVERAL VIEWS OF THE DRAWINGS

FIG. 1 is a functional block diagram illustrating a data processing environment, generally designated 100, in accordance with an embodiment of the present invention.

FIG. 2 is a flow chart depicting operational steps of a game reward program for determining achievements tailored to a gaming group within the data processing environment of FIG. 1, in accordance with an embodiment of the present invention.

FIG. 3 depicts a block diagram of the components of the server computer of FIG. 1, in accordance with an embodiment of the present invention.

### DETAILED DESCRIPTION

Online video and computer games offer a game player the ability to choose or design in-game characters or avatars by selecting preferred game settings, such as appearance, character attributes and strengths, along with a list of friends, items earned and other game achievements that can be tracked per game. Embodiments of the present invention recognize that some players or users may become discouraged or uninterested in playing the game when the level of challenges or achievements is inappropriate compared to a player's skill level or playing style. In some cases, game challenges determined by a game developer or game service provider may be too overwhelming for a less skilled or less dedicated player while in other cases, initial game achievement levels may be too easy for a skilled or dedicated player. In these and other cases, potential game play and the associated revenue for the game developer or game service provider may be lost or reduced. Additionally, after a game has been introduced and in the marketplace for a period of time, users of a game become experienced and game developers may need to add achievement levels to extend the game challenges as each player progresses through the game.

Embodiments of the present invention provide a method, program and a system to adaptively create new or additional game challenges and achievements. The changes to challenges and achievements may be based on tracking game actions taken by a player, including analyzing skills, achievement level, strengths of a user, and game preferences, for example, game genre, terrain played, preferred character and character skills, across multiple games. The tracked game actions are compiled to determine a user profile that can be used to identify players of similar skills, game preferences, strengths and achievements. Embodiments of the present invention identify and utilize game information of a user and of other players across the multiple games to identify a group of similar players with substantially similar experience, skills, game preferences and playing style as the user. Embodiments of the present invention determine additional or modified achievements and challenges within a game tailored to the identified group of players to enhance the game experience of the group of players. Game information can include the user's actions within a game that can be measured, recorded, and tracked for one game or across multiple games, for example, time of play or characters selected for an avatar that illustrate the way a user interacts with the game or games.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

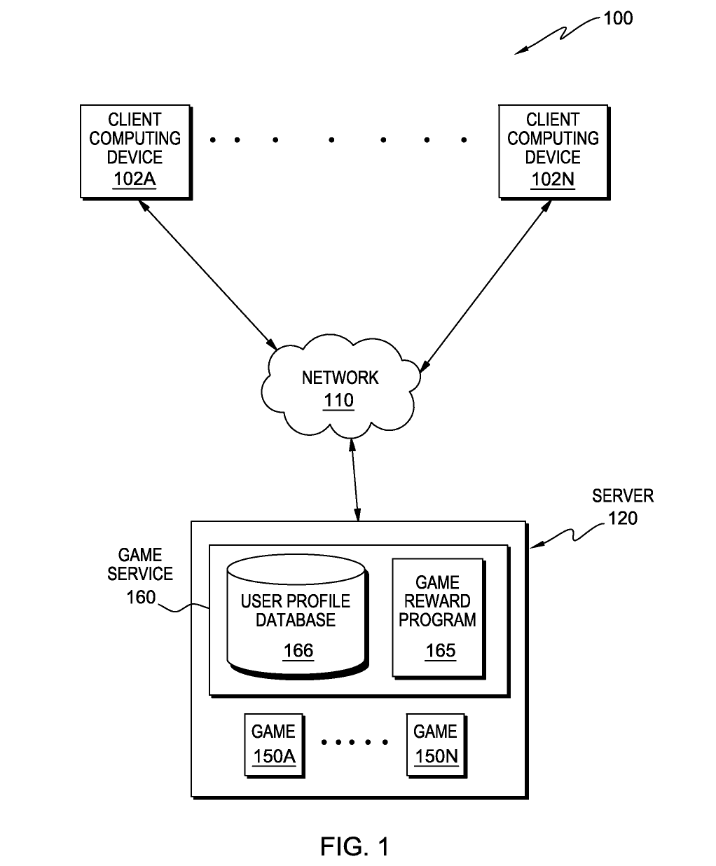

The present invention will now be described in detail with reference to Figures. FIG. 1 illustrates a data processing environment, generally designated 100, including client computing devices 102A to 102N and server 120, connected via network 110, in accordance with an exemplary embodiment of the present invention. In an exemplary embodiment of the present invention, data processing environment 100 is a multiplayer online gaming system environment including a game service 160 and games 150A to 150N, where games 150A to 150N each represent one of a variety of games provided by game service 160.

Network 110 can be, for example, a local area network (LAN), a wide area network (WAN), virtual local area network (VLAN) such as the Internet, or a combination of any of the three, and can include wired, wireless, or fiber optic connections. In general, network 110 can be any combination of connections and protocols that will support communications between server 120 and client computing devices 102A to 120N.

In the exemplary embodiment, client computing device 102A to client computing device 102N are client computing devices used to play various multiplayer online games, such as games 150A through 150N on server 120. A client computing device, for example client computing device 102A, may access one or more multiplayer online games or massively multiple player online games (MMOG). Client computing devices 102A to 102N are connected to games 150A to 150N and game service 160 on server 120 by network 110. In various embodiments, client computing devices 102A to 102N may be desktop computers, laptop computers, handheld computers, personal digital assistants (PDA), cell phones, smart phones, game systems or other similar electronic devices capable of receiving and sending electronic signals or communicating with a multiplayer online game, such as any of games 150A through 150N and game service 160 over network 110.

In various embodiments, server 120 may be a server computer, a server computer system such as a management server, a web server, or any other electronic device or computing system capable of sending, receiving, and processing data. Server 120 may be a group of clustered computing devices utilizing multiple computing devices such as a cloud computing environment. In some embodiments, server 120 may be a cognitive computing device. Server 120 includes games 150A to 150N (hereafter referred to as games 150) and game service 160. Game service 160 includes game reward program 165 and user profile database 166. Server 120 is connected to client computing devices 102A-102N via network 110.

In an exemplary embodiment, games 150 are massively multiple player online games (MMOGs) which include massively multiplayer online role-playing games (MMORPGs) and other similar variations on MMOGs. In other embodiments, games 150 may be a multiplayer online game or similarly connected games. Games 150 may be any type of multiplayer online game or MMOG, for example, interactive war games, role playing games, first person shooter games, educational games, music games, sports games, or strategy games. Each of the games 150 may include numerous and varied goals, tasks, objectives, and achievements, such as levels, various terrains, weapons, additional tools, resources, secret power-ups, items to collect and increased player interactions for example. In an embodiment, game reward program 165 includes a player or user tracking mechanism such that game reward program 165 configures each game to measure and record game actions for each user, such as time of play, preferred character, terrain typically used, items earned, achievement levels, friends or repeated player interactions, style or pattern of play and any other user actions that may be tracked within a game. In some embodiments of the present invention, game reward program 165 may track user game play metrics or record game actions of the user and send the game actions of the user or the user game play metrics to a database or other storage device.

The game actions for each user, for example, a user operating one or more of client computing devices 102A to 102N to interact with games 150, include measureable, recordable, and trackable actions taken by the user within a multiplayer online game or MMOG. A record of game actions for the user within each accessed game of games 150 may be saved in a database, for example user profile database 166. In some embodiments, game actions or game play metrics for the user may be dynamically updated during play of game at set time intervals or upon completion of new levels, tasks or other achievements. In an embodiment, a record of the tracked user game play actions or the user's game actions may be saved or recorded by each game and sent to user profile database 166 when a user exits or closes each of games 150. In the exemplary embodiment, games 150 are located on server 120 along with game service 160. In other embodiments, games 150 may be on another server, server system, or a group of clustered computers such as in a cloud computing environment. In still other embodiments, games 150 may be on client computing devices, such as any of client computing devices 120A to 120N.

Game service 160 on server 120 includes game reward program 165 and user profile database 166. Game service 160 receives user game actions collected by games 150 and stores the information in user profile database 166. Within game service 160, game reward program 165 may retrieve the user's game actions from user profile database 166. In an exemplary embodiment, game service 160 receives and sends data regarding user game actions and game challenges or achievements to games 150 on server 120. In other embodiments, game service 160 may communicate directly with client computing devices 102A to 102N or with games 150 on another server or server system.

Game reward program 165 in game service 160 utilizes data such as a user profile and user game actions from user profile database 166, including for example, level of achievements, skill level, preferred characters, preferred terrains, friends, weapons, items gathered, time to reach an achievement, time played, preferred time of day to play and any other preferences, rewards or challenges associated with a user's play of game within a game and across the multiple games of games 150. Game reward program 165 retrieves a user's game actions which include cross-game metrics or cross-game actions which compare a user's game actions between games. Cross-game metrics or cross-game actions include identification of similar game actions metrics across multiple games, to analyze the data and create a user profile that can be compared to other player's profiles. The user profile, including user game actions and cross-game actions may be compared to other players user profiles and game actions.

Using the game actions of a user, including cross-game actions, a group of similar skilled players with similar interests, game preferences, experience or playing style may be determined. A user's experience may be an experience such as building a dam or climbing a mountain, a level of experience such as a rating of expert marksman, or a measured time of play in a specific activity, terrain or game. Additionally, a similar level or similar skill is one that is close in skill level or a matching skill type and skill level. For example, for measurable items such as levels, a similar level may be within ten to fifteen percent of another skill level, either a lower or a higher skill level. A similar skill to a driver skilled at maneuvering a car around obstacles in a city street could be a pilot maneuvering a helicopter around topographic obstacles in a race simulation game for example.

Game reward program 165 determines a group of users which may be a gaming group of users with similar skill, style of play, experience, playing preferences or interests using game actions and cross-game metrics. Game reward program 165 retrieves the game actions which include cross-game actions for each user of game service 160 and compares and analyzes the game actions to determine a group of similar users. Using the game actions gathered on the group of users, game reward program 165 can create additional or modified challenges or achievements for a game, game 150A for example, that may be tailored to a specific group based on user skills, preferences, level of experience, and style of play or other defined characteristics. The achievement may be determined based on the substantially similar game actions, for example, a similar skill level for the group of users. Game reward program 165 compares the pre-set or pre-determined achievements in a game or the initial game achievement levels set by the game developers to the skill level, group interests, etc. of the group of users or gaming group to create achievements or challenges tailored to the group of users or gaming group. The achievements may be automatically generated to enhance the user's playing experience within a game. Game reward program 165 may send the created game challenges or achievements to the game for example, game 150A, to be included in game 150A for the specified group of users.

User profile database 166 receives and stores game actions for each user of each multiplayer online game of games 150. The user game actions may be sent by games 150 to user profile database 166 where they may be stored by game, user identity (userid), or user name. User profile database 166 may receive data from games 150 and may provide data on a user or specified userid as queried by game reward program 165.

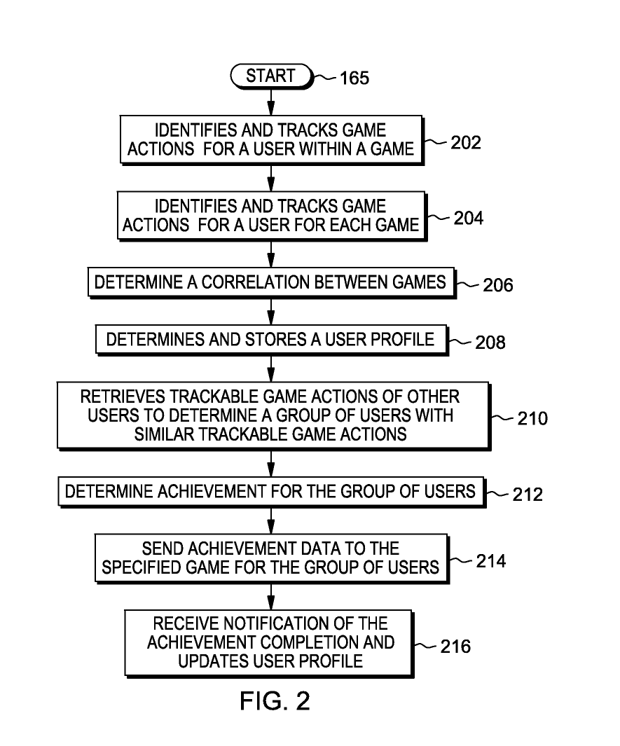

FIG. 2 is a flow chart depicting operational steps of game reward program 165 for determining achievements tailored to a gaming group within data processing environment 100, in accordance with an embodiment of the present invention.

In step 202, game reward program 165 identifies and tracks game actions for a user within a game, for example, game 150A. Game actions for the user include trackable, measurable, or recordable actions the user performs within the game. For example, user game actions may include but, are not limited to the following:
i.) encounters with x number of creatures
ii.) dispatch x number of creatures in a location
iii.) heals x number of players or users
iv.) x quests completed
v.) involvement in a game economy
vi.) leadership of groups of users (frequency or number of clan/group members)
vii.) items acquired
viii.) time taken to achieve each of the items in lines i. through vii.
ix.) frequency/time of interaction with other users
x.) achievements already achieved and type of achievements generally obtained
xi.) amount of time spent in certain areas of game terrain or lands
xii.) amount of time spent in conflict with other users
xiii.) total time the game is played
xiv.) frequency of play
xv.) length of each time played
xvi.) time spent engaged in type of activities (adventuring, social, etc)

In step 204, game reward program 165 identifies and tracks game actions for the user for each multiplayer online game played by the user within data processing environment 100 that can be tracked by game service 160. Game actions for the user may be identified and retrieved by game reward program 165 for each of games 150, which have been played by the user. Games 150 can track and collect game action data in each game played by the user and sent by each game to user profile database 166. In some embodiments, game actions for the user for each of games 150 may be grouped by game genre (e.g. sports, music, role-playing game, etc). In online video and computer games, it is common for a user to have multiple userids, sometimes within a game and between games. In one embodiment, game reward program 165 may correlate as many of the userids to the specific user when appropriate data is provided by games 150 or client computing devices 120A through 120N via network 110. For example, the user may be accessing a game, for example, game 150A, from a specific client computing device, such as client computing device 102A, and the user logs on to another game, for example, game 150N from the same client computing device 102A at the same time with another userid, or immediately after playing 150A, and game reward program 165 may correlate the userids as potentially being the same user.

In step 206, game reward program 165 determines a correlation between games using game actions which may be compared between games, e.g., cross-game metrics. Game reward program 165 can determine a correlation by comparing and analyzing game actions for the user for similar activities within different games. For example, user1 played game 150A and now also plays game 150B, where both game 150A and game 150B are role playing games of the same genre. In game 150A, user1 dispatched 500 orcs in ten hours of play. In game 150B, user1 dispatches 1000 orc-like creatures which include “orc” in their name in ten hours of play. Game reward program 165 can make a correlation between a user dispatching orc-like creatures between game 150A and game 150B using user1's game action metrics. The correlation determined could be dispatching “orcs” in game 150B is equal to twice the number of orcs dispatched in game 150A (1000 orcs in game 150B equals two times 500 orcs in game 150A). In another example, cutting trees in one game and gathering berries in another game could be used to generate a correlation between games on gathering resources. By comparing the data from a user's experience in various games and by analyzing game actions across games, game reward program 165 may build correlations between various games. Additionally, in some embodiments, game reward program 165 may compare multiple users' game actions and skill level in various or multiple games providing a better understanding of both the user's skill level compared to other users and a better correlation between games.

In step 208, game reward program 165 determines and stores a user profile for the user. The user profile for the user summarizes and consolidates the data collected on the user's game actions. The user profile may summarize the user's experience including, for example, play time, level of achievements, time to reach each achievement, preferred game genre, preferred characters and accessories, and playing style, such as an explorer who likes to experience various terrains or elements in the game, a warrior with an aggressive attack style, or a collector who collects artifacts. The user profile includes the user's game actions across games 150 played by the user to characterize for example, skill level, preferences, such as characters or weapons, friends and style of play. Game reward program 165 stores the user profile for the user in user profile database 166.

In step 210, game reward program 165 retrieves game actions from user profile database 166 tracked for other users and determines a group of users with similar user profiles and tracked game actions, including cross-game metrics. In an embodiment, game reward program 165 retrieves user profiles for other users from user profile database 166. Demographic data for a group of similar users may be based on retrieved data which can include game actions which include cross-game actions such as measured game playing time, game genres played, skill level, experience, user game preferences, such as characters or terrain, achievement level, time to accomplish achievements, style or pattern of play and friends or groups of friends, and collective actions or playing style of the group of friends.

A gaming group or group of similar users may be determined based on a number of objectives. For example, a group of similar users may be determined by grouping users of a similar genre game with similar skill level and style of play such as a group of very skilled users with significant time investment who play war games and prefer to be snipers. In an embodiment, the group of similar users or gaming group may be determined by identifying users with similar skill level, game preferences, experience and style of play.

The group of users, or gaming group, can be dynamic and the group demographics and user profiles identified within the gaming group may be modified as additional or new game genres or games are introduced. Additionally, a user may change their association with a gaming group as the user's skills or interests evolve or change, such as a level of game participation or a change in type of preferred activity. For example, a user focusing on wizardry skills may become interested in clan leadership in agricultural based societies spending significant time acquiring leadership of various clans thus, changing gaming group affiliation. In some embodiments, the gaming group or group demographics may be driven by social network participation, for example, a gaming group could be determined by relationships on social media. In another embodiment, posts or comments by friends or another social media identified group on specific elements, new aspects of a game or a new game on a social media platform may be retrieved by game reward program 165 and used in determining achievements for the group. In some cases, the gaming group may be selected or identified by game reward program 165 using input from a game service provider or a game developer who wants to focus on selecting users involved in a specific activity or area within a game or games. A user may be a part of one or more gaming groups. For example, the user may play fantasy MMOG games related to magic during the day and play sports related multiplayer online games at night and therefore be associated with two different gaming groups.

In step 212, game reward program 165 determines an achievement or challenge for the group of users. Game reward program 165 creates customized achievements tailored to the skills, experiences, interests, user preferences, and style of play of the gaming group based on an analysis of game actions in the user profile data and cross-game metrics. Utilizing the analysis of the user game actions, new or modified challenges, tasks, objectives, or achievements may be determined for a user in the gaming group. For example, a gaming group including users with a high level of experience and high playing time may historically meet goals for gathering items in a shorter than average time. Game reward program 165 may set an achievement for the gaming group thirty percent higher than the average achievement attained. Similarly, a gaming group including users with a low level of experience and modest playing time historically takes longer than the average gaming group to attain a goal for gathering items. In this example, game reward program 165 may set an achievement or goal for this gaming group to be only ten percent higher than the average achievement or goal attained.

In another embodiment of the present invention, game reward program 165 retrieves user profiles from profile database 166, analyzes and compares the user profiles to determine a gaming group of similar users. Comparisons of user profiles may include grouping users by play style, such as an explorer who likes to experience various terrains or elements in the game, a warrior or sports player with an aggressive attack style or play style and other characterizations of game actions across multiple games, for example, a user who prefers characters such as wizards and healing spells.

Game reward program 165 sets an additional achievement or a modified level of achievement using identifying information on the gaming group including user profile data and game actions such as level of achievement or highest level of achievement of the group, skills, interests or time of play and based on any of a number of objectives. In one embodiment of the present invention, game reward program 165 identifies the highest level of achievement attained by a user in the gaming group for a specific activity to determine an appropriate new achievement for the gaming group. For example, the highest level of achievement for crafting may be attained by a user in the gaming group completing 15 crafting related quests in zone 2. Game reward program 165 may determine a new achievement level for the gaming group is to complete 15 crafting related quests in zone 5, which requires a higher level of skill than zone 2.

In some embodiments, game reward program 165 may be programmed to create new achievement levels that are a percentage, for example, twenty percent, more difficult than the current highest achievement level of the gaming group. For example, a gaming group may loot two hundred items of armor and game reward program 165 determines that looting two hundred and forty items of armor may be a new achievement for the group. In an embodiment, game reward program 165 may determine new achievements based on the most popular activity of the gaming group where the most popular activity may be determined by identifying the activity where the members of the gaming group spends the most time playing. Game reward program 165 may identify the highest level of achievement in the most popular activity in a game and increase that level by a set percentage, for example twenty five percent, for the new achievement level. For example, a gaming group spends the largest percent of the group playing time dispatching gnomes in one of game 150N. A user has dispatched 400 gnome archers, the highest level for the gaming group in the game 150N, and game reward program 165 can determine that dispatching 500 gnome archers would be a new level of achievement for the gaming group in the game 150N. The set percentage may be pre-determined by a game developer or game service provider.

In some embodiments, game reward program 165 may identify users with a similar level of achievement in one area or a specific game element, to determine a possible level of achievement to apply in other areas or elements of the game based on other user's progression. For example, in an educational multiplayer online game, a number of users may be excelling in the algebra section or area of the game, and many of the users in the algebra section are also participating with success in the calculus section of the game. Game reward program 165 can retrieve and analyze the game actions for the educational multiplayer online game, and create an achievement related to the calculus section for the group of users succeeding in the algebra section but, not currently participating in the calculus section.

In another embodiment of the present invention, game reward program 165 retrieves and analyzes user profiles and game actions between games of different genres to determine achievements. For example, a large group of users participate in a soccer multiplayer online game or MMOG. Game reward program 165 collects and analyzes user profiles from the group of soccer game users, identifying that the group of users with outstanding dribbling skills in the soccer game also have outstanding speed and mobility in a rough terrain section of a combat game, such as a game 150N. An achievement in the game 150N relating to speed and mobility in the rough terrain section or another similar section of the game 150N may be set by game reward program 165 for soccer players with outstanding dribbling based on the analysis of user profiles and cross game genre game actions.

In another embodiment, game reward program 165 may be programmed to target a time objective for user play. Based on the game actions retrieved by game reward program 165 from user profile database 166, game reward program 165 can estimate a new achievement with an expected period of time to attain the achievement. For example, an objective of two weeks playing time to attain a new achievement may be set for a gaming group in game reward program 165. In analyzing the retrieved data from user profile database 166, game reward program 165 identifies three users who have built a village and stockade in eight days in game 150A. The new achievement level for the gaming group may be to build two villages with stockades in game 150A. In some embodiments, the criteria or objectives set for new achievement levels could be randomized or alternate between new achievements for various activities, for example, the most popular activity by time of play and the fastest growing activity in terms of new users.

In embodiments, in addition to determining an additional achievement or challenge, game reward program 165 may generate rewards for attaining the additional level of achievement or challenge by any number of methods. Rewards may be dynamically generated based on the activity involved with attaining the achievement that generated the reward or in other words, rewards may be related to the activity that earned them. For example, meeting a new achievement level for an archer dispatching ores may be to get a bow with an extra fifty yards of range or a wizard using a spell to complete the challenge may get three new spells. Game reward program 165 may award a power boost or an increase in power (e.g., a twenty five percent increase in armor strength), a new skill such as boat building, new powers or access to new terrains. In some embodiments, rewards may be randomized to encourage users to expand their field of play or targeted to new game extensions when game developers add new options or game extensions.

In step 214, game reward program 165 sends achievement data, along with any rewards and reward names associated with the achievement to the specified game, for example, game 150A, for the group of users. Game reward program 165 can send the userids for the identified members of the gaming group to which the new achievement was tailored. In an embodiment, game 150A automatically updates and installs the achievement and any associated rewards received from game reward program 165 and sends notification of the achievement level to the group of users. In some embodiments, game reward program 165 may send notification of the new achievements directly to the userids of the gaming group members.

In step 216, game reward program 165 receives notification of achievement completion and updates the user profile in user profile database 166. Game reward program 165 may receive notification of achievement completion dynamically as it occurs or when the user signs-off or exits the game. When the achievement is attained by the gaming group, game reward program 165 may automatically update game actions for each user for the game (step 202).

Game reward program 165 may name rewards for attaining additional achievements dynamically or automatically based on pre-determined methods. Reward names may be automatically generated by game reward program 165 using verbs, nouns, adjectives or adverbs related to the achievement. For example, a reward related to a farming challenge could be a ten percent increase in produce yield and may be named “Grow′em bigger” or “Bigger Produce.” In some embodiments, the reward name for attaining the new achievement may involve the name, userid or other user attribute of the user who met the additional achievement level. In other embodiments, a user may be provided an opportunity to select a name from a pop-up list of pre-determined names or to create a reward name of his or her choosing. In some cases, attaining the additional achievement level may trigger a game developer or game service provider to create a reward name or other attributes associated with the reward.

In an embodiment, game reward program 165 updates the user's game actions (step 202) upon receiving notification of achievement completion and continues with the process steps illustrated in FIG. 2 by continuing on to step 204 after updating the user's game actions. In other embodiments, game reward program 165 may delay a pre-determined or random time before initiating a repeat of determining achievements (step 212). For example, game reward program 165 may only create one new achievement a week or perhaps, limit new achievements to two per day. In another embodiment, game service 160 administrators or a game developer may determine the rate of achievement offerings to the gaming group or to a set of gaming groups.

Upon the gaming group attaining the level of achievement, game reward program 165 may track statistics and objectives relating the new achievement completion. Game reward program 165 may measure the attained achievement in terms of gaming group total playing time in the activity related to the achievement, the time to complete the achievement, the average percent completion of the achievement level within the gaming group, the number of players to complete the achievement when timed or a set time may be included in the achievement, an increase or decrease in the gaming group participation by number of users or playing time per user for example. The statistics gathered may be provided to game service 160 providers or customers, such as owners or developers of games 150, upon request. In some embodiments, game reward program 165 may be on an intelligent or knowledge based computer or server system that may automatically make adjustments to game reward program 165 utilizing the statistics provided on attaining achievements.

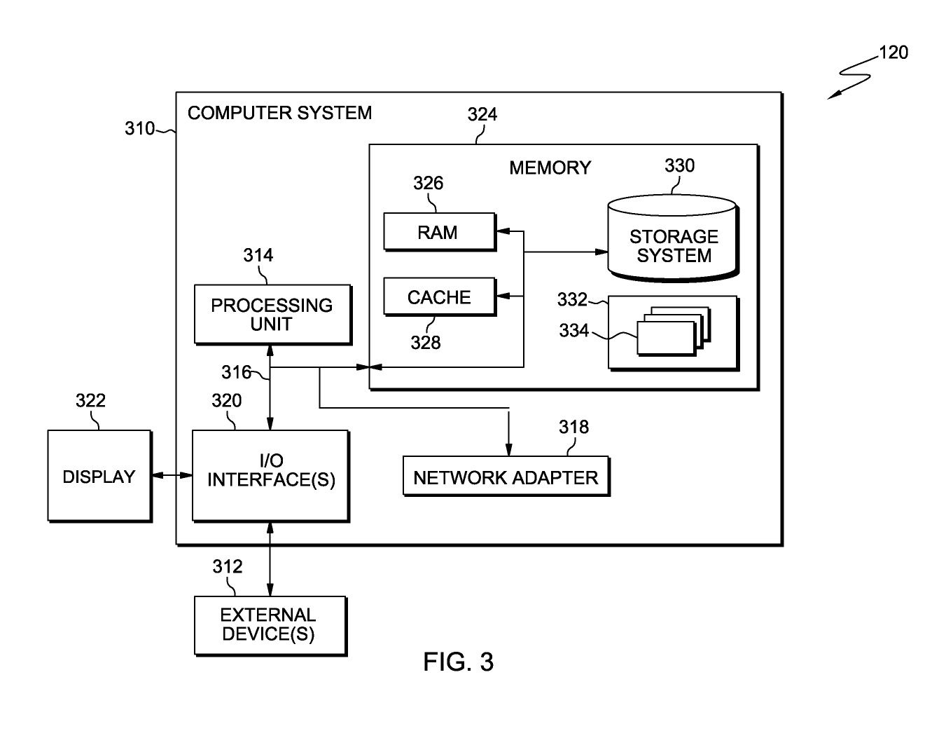

FIG. 3 depicts a block diagram of the components of server 120, in accordance with one embodiment of the present invention. It should be appreciated that FIG. 3 provides only an illustration of one implementation and does not imply any limitations with regard to the environments in which different embodiments may be implemented.

Server 120 includes the components shown in computer system 310. In the illustrative embodiment, game reward program 165 in game service 160 in the data processing system 100 is shown in the form of a server 120 however, the capabilities provided by game reward program 165 and game service 160 may be provided by a remote computer, server, or a cloud of distributed computing devices. The components of computer system 310 may include, but are not limited to, one or more processors or processing units 314, a system memory 324, and a bus 316 that couples various system components including system memory 324 to processing unit 314.

Bus 316 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system 310 typically includes a variety of computer system readable media. Such media may be any available media that is accessible by computer system 310, and it includes both volatile and non-volatile media, removable and non-removable media.

System memory 324 can include computer system readable media in the form of volatile memory, such as random access memory (RAM) 326 and/or cache memory 328. Computer system 310 may further include other removable/non-removable, volatile/non-volatile computer system storage media. By way of example only, storage system 330 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM, or other optical media can be provided. In such instances, each can be connected to bus 316 by one or more data media interfaces. As will be further depicted and described below, system memory 324 may include at least one computer program product having a set (e.g., at least one) of program modules that are configured to carry out the functions of embodiments of the invention.

Program 332, having one or more sets of program modules 334, may be stored in memory 324 by way of example, and not limitation, as well as an operating system, one or more application programs, other program modules, and program data. Each of the operating systems, one or more application programs, other program modules, and program data, or some combination thereof, may include an implementation of a networking environment. Program modules 334 generally carry out the functions and/or methodologies of embodiments of the invention as described herein. Computer system 310 may also communicate with one or more external device(s) 312 such as a keyboard, a cell phone, a pointing device, a display 322, etc., or one or more devices that enable a user to interact with computer system 310 and any devices (e.g., network card, modem, etc.) that enable computer system 310 to communicate with one or more other computing devices. Such communication can occur via Input/Output (I/O) interface(s) 320. Still, computer system 310 can communicate with one or more networks such as a local area network (LAN), a general wide area network (WAN), and/or a public network (e.g., the Internet) via network adapter 318. As depicted, network adapter 318 communicates with the other components of computer system 310 via bus 316. It should be understood that although not shown, other hardware and software components, such as microcode, device drivers, redundant processing units, external disk drive arrays, RAID systems, tape drives, and data archival storage systems may be used in conjunction with computer system 310.

The terminology used herein is for the purpose of describing particular embodiments only and is not intended to be limiting of the invention. It should be appreciated that any particular nomenclature herein is used merely for convenience and thus, the invention should not be limited to use solely in any specific function identified and/or implied by such nomenclature. Furthermore, as used herein, the singular forms of “a,” “an,” and “the” are intended to include the plural forms as well, unless the context clearly indicates otherwise.

The description of the present invention has been presented for purposes of illustration and description, but is not intended to be exhaustive or limited to the invention in the form disclosed. Many modifications and variations will be apparent to persons of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of determining achievements for online computing game users, the method comprising:
a computer identifying one or more game actions of a first user for one or more online computing games;
the computer identifying one or more game actions of a plurality of users for the one or more online computing games;
the computer determining that a game action of the first user is substantially similar to a game action of at least one user of the plurality of users;
responsive to the computer determining the game action of the first user is substantially similar to the game action of the at least one user, the computer identifying a group of users, the group of users including at least the first user and the at least one user of the plurality of users; and
the computer determining at least one achievement for the group of users, based, at least in part, on the game action of the first user and the game action of the at least one user.

2. The method of claim 1, wherein the computer identifying the one or more game actions of the first user includes the computer identifying measureable actions of the first user in each game of the one or more online computing games.

3. The method of claim 1, wherein the one or more game actions include at least one of: a skill level, a time of play, an experience, one or more achievements, one or more game preferences, and one or more interests.

4. The method of claim 1, wherein the computer identifying a group of users further comprises:
the computer determining the game action of the first user and the game action of the at least one user of the plurality of users contain at least one of a substantially similar skill level, a matching game preference, and a related interest.

5. The method of claim 1, further comprising:
the computer determining a change in at least one of the one or more game actions of the plurality of users; and
the computer modifying, based, at least in part, on the change in the at least one of the one or more game actions, the group of users.

6. The method of claim 1, further comprising:
the computer determining an additional game of the one or more online computing games; and
the computer modifying, based, at least in part, on the additional game, the group of users.

7. The method of claim 1, further comprising:
the computer determining the first user attained the at least one achievement; and
responsive to the computer determining the first user attained the at least one achievement, the computer determining at least one additional achievement for the group of users.

8. The method of claim 1, wherein the computer determining at least one achievement for the group of users further comprises:
the computer identifying information for the group of users, the information including one or more of: a level of achievement of users in the group, one or more skills of users in the group, one or more interests of users in the group, and an experience measured by time of play of users in the group; and
the computer determining based, at least in part, on the identified information for the group of users, at least one achievement for the group of users, wherein the at least one achievement includes at least one of: an increased level of achievement, a new group skill, one or more additional items to obtain, and one or more rewards.

9. The method of claim 1, further comprising the computer sending the at least one achievement for the group of users to the group.

10. A computer program product for determining achievements for online computing game users, the computer program product comprising:
one or more computer readable storage media and program instructions stored on the one or more computer readable storage media, the program instructions comprising:
program instructions to identify one or more game actions of a first user for one or more online computing games;
program instructions to identify one or more game actions of a plurality of users for the one or more online computing games;
program instructions to determine that a game action of the first user is substantially similar to a game action of at least one user of the plurality of users;
responsive to the computer determining the game action of the first user is substantially similar to the game action of the at least one user, program instructions to identify a group of users, the group of users including at least the first user and the at least one user of the plurality of users; and
program instructions to determine at least one achievement for the group of users, based, at least in part, on the game action of the first user and the game action of the at least one user.

11. The computer program product of claim 10, wherein the program instructions to identify the one or more game actions of the first user include program instructions to identify measureable actions of the first user in each game of the one or more online computing games.

12. The computer program product of claim 10, wherein the one or more game actions include at least one of: a skill level, a time of play, an experience, one or more achievements, one or more game preferences, and one or more interests.

13. The computer program product of claim 10, wherein the program instructions to identify a group of users further comprise:
program instructions to determine the game action of the first user and the game action of the at least one user of the plurality of users contain at least one of a substantially similar skill level, a matching game preference, and a related interest.

14. The computer program product of claim 10, further comprising:
program instructions to determine a change in at least one of the one or more game actions of the plurality of users; and
program instructions to modify, based, at least in part, on the change in the at least one of the one or more game actions, the group of users.

15. The computer program product of claim 10, further comprising:
program instructions to determine the first user attained the at least one achievement; and
responsive to the computer determining the first user attained the at least one achievement, program instructions to determine at least one additional achievement for the group of users.

16. The computer program product of claim 10, wherein the program instructions to determine at least one achievement for the group of users further comprise:
program instructions to identify information for the group of users, the information including one or more of: a level of achievement of users in the group, one or more skills of users in the group, one or more interests of users in the group, and an experience measured by time of play of the group; and
program instructions to determine based, at least in part, on the identified information for the group of users, at least one achievement for the group of users, wherein the at least one achievement includes at least one of: an increased level of achievement, a new group skill, one or more additional items to obtain, and one or more rewards.

17. A computer system for determining achievements for online computing game users, the system comprising:
one or more computer processors;
one or more computer readable storage media;
program instructions stored on at least one of the one or more computer readable storage media for execution by at least one of the one or more computer processors, the program instructions comprising:
program instructions to identify one or more game actions of a first user for one or more online computing games;
program instructions to identify one or more game actions of a plurality of users for the one or more online computing games;
program instructions to determine that a game action of the first user is substantially similar to a game action of at least one user of the plurality of users;
responsive to the computer determining the game action of the first user is substantially similar to the game action of the at least one user, program instructions to identify a group of users, the group of users including at least the first user and the at least one user of the plurality of users; and
program instructions to determine at least one achievement for the group of users, based, at least in part, on the game action of the first user and the game action of the at least one user.

18. The computer system of claim 17, wherein the one or more game actions include at least one of the following: a skill level, a time of play, an experience, one or more achievements, one or more game preferences, and one or more interests.

19. The computer system of claim 17, further comprising:
program instructions to determine a change in at least one of the one or more game actions of the plurality of users; and
program instructions to modify, based, at least in part, on the change in the at least one of the one or more game actions, the group of users.

20. The computer system of claim 17, wherein the program instructions to determine at least one achievement for the group of users further comprise:
program instructions to identify information for the group of users, the information including one or more of: a level of achievement of users in the group, one or more skills of users in the group, one or more interests of users in the group, and an experience measured by time of play of the group; and
program instructions to determine based, at least in part, on the identified information for the group of users, at least one achievement for the group of users, wherein the at least one achievement includes at least one of: an increased level of achievement, a new group skill, one or more additional items to obtain, and one or more rewards.
